(19) United States
(12) Patent Application Publication
(10) Pub. No.: US 2014/0151381 A1
(43) Pub. Date: Jun. 5, 2014

(54) Releasable connection between a handle and a pan, and a pan with said connection

(71) Applicant: Giuseppe Bogani, Rovellasca (IT)

(72) Inventor: Giuseppe Bogani, Rovellasca (IT)

(21) Appl. No.: 14/117,603

(22) PCT Filed: Aug. 23, 2011
(86) PCT No.: PCT/IB11/53688

§ 371 Date: Nov. 13, 2013

(30) Foreign Application Priority Data
May 13, 2011 (IT) MI2011A000840

(51) Int. Cl. A47J 27/00

(52) U.S. Cl. CPC A47J 27/002
USPC 220/573.1; 72/347

(57) ABSTRACT

A method for the production of a pan having, incorporated, at least one engaging seat for a handle with releasable engaging means at its end, comprises the steps of cutting a blank from a metal sheet, forming by means of deep-drawing from said blank a pan body, leaving a flat edge which projects radially over at least a part of the pan circumference, and forming in this projecting edge the said engaging seat for the handle. Advantageously the metal sheet may be made of aluminium.

### CLAIM TO PRIORITY

This application claims priority to PCT application PCT/IB2011/053688, which has an international filing date of Aug. 23, 2011, which has a priority date of May 13, 2011 based on Italian application MI2011A000840.

The present invention relates to a method for the production of a pan of the type equipped with a removable handle. Here “removable handle” is understood as meaning a handle which can be easily engaged and disengaged as and when required, for example in order to stow away or wash the pan.

In the art separable connections between a handle and pan are known. An example of such a type of connection is illustrated in EP 1,121,041. Such a connection makes use of the reaction between two opposite surfaces of a rotating cam in order to achieve firm fixing of the handle once the connection is completed.

A bracket provided with a seat for engaging the handle is fastened to the pan (for example by means of riveting or clinching). Such a structure has the drawback that it is required to produce two parts (pan and bracket) and firmly fasten them together. Apart from the additional cost, there is the risk that, with time and subsequent expansion due to heat, the joint will come loose and the bracket will no longer be stably connected to the pan.

The general object of the present invention is to overcome the abovementioned drawbacks by providing a production method which is able to produce, by means of a limited number of processing operations and at a relatively low cost, a pan which has, incorporated, an engaging seat for a removable handle

In view of this object the idea which has occurred, according to the invention, is to provide a method for the production of a pan having, incorporated, at least one engaging seat for a handle with releasable engaging means at its end, comprising the steps of cutting a blank from a metal sheet, forming by means of deep-drawing from said blank a pan body, leaving a flat edge which projects radially over at least a part of the pan circumference, and forming in this projecting edge the said engaging seat for the handle.

A pan according to the method is also claimed here.

In order to illustrate more clearly the innovative principles of the present invention and its advantages compared to the prior art a possible example of embodiment applying these principles will be described below, with the aid of the accompanying drawings. In the drawings:

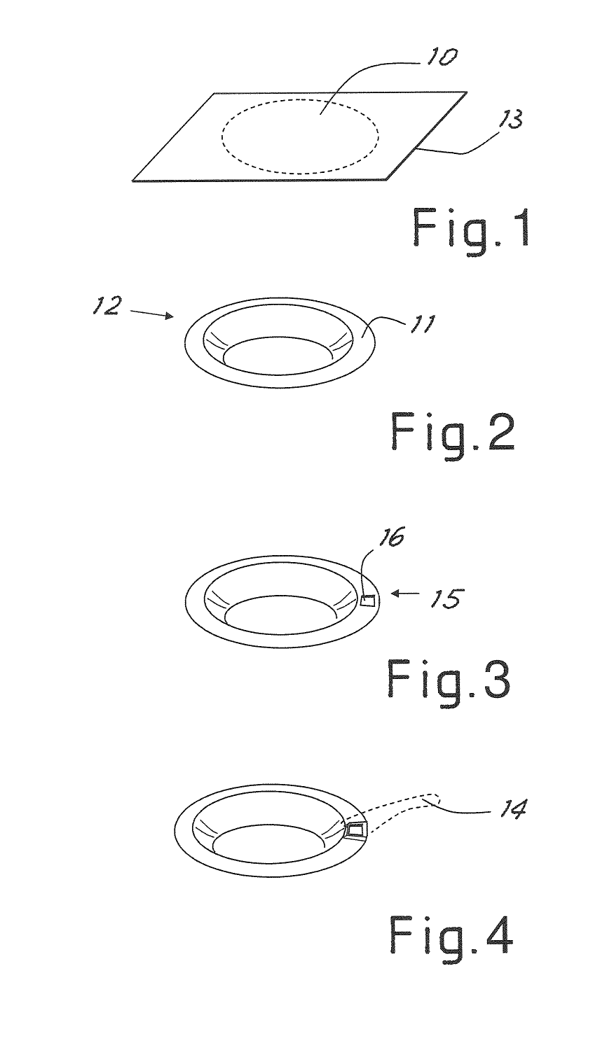

FIGS. 1 to 4 show schematic perspective view of steps of the method according to the invention;

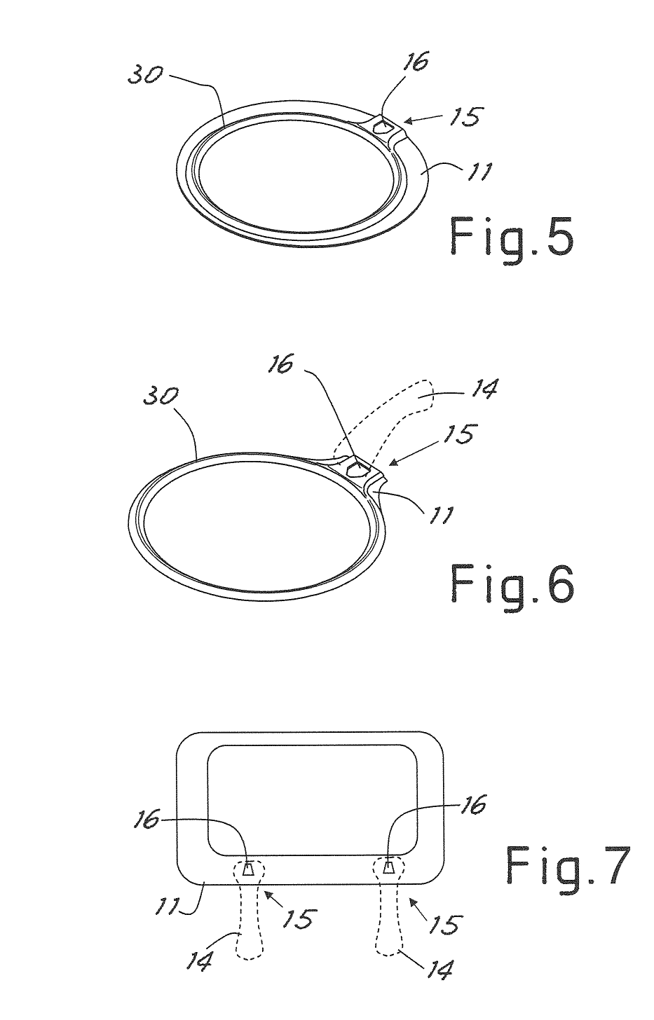

FIGS. 5, 6 and 7 show schematic perspective views of constructional variants of the pan;

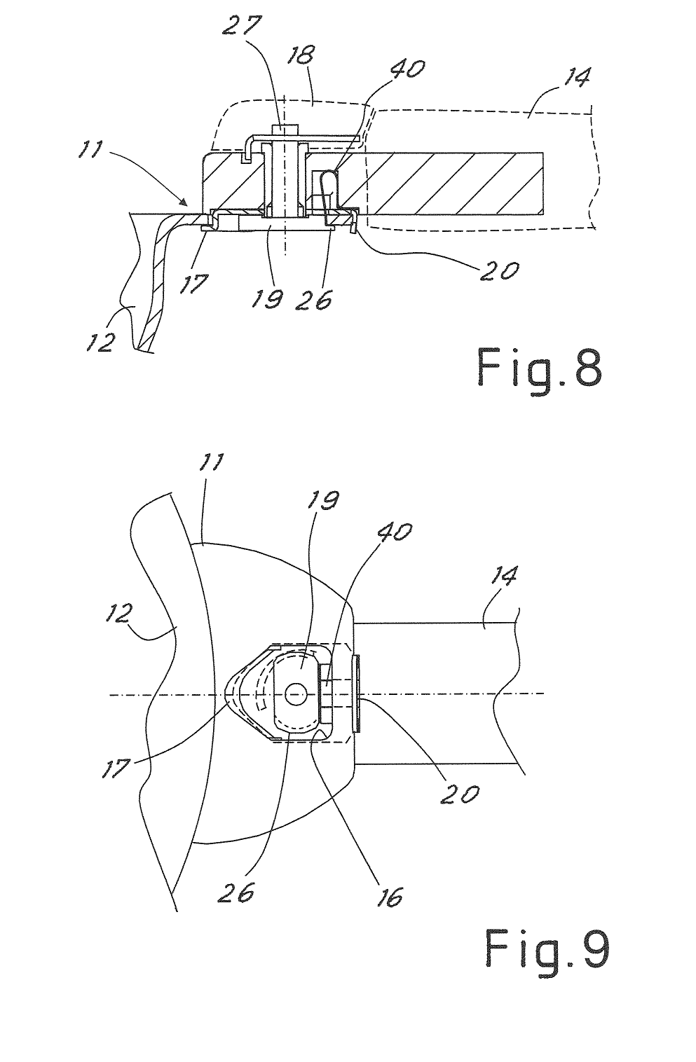

FIGS. 8 to 9 show schematic views, longitudinally sectioned and from below, respectively, of the zone for engagement between a removable handle and a pan according to the method.

With reference to the Figures, a method for the production of a pan with an engaging seat for a handle with releasable engaging means, comprising the steps of cutting a blank 10 from a metal sheet 13. Advantageously the metal sheet used is made of aluminium. Here the term “pan” is understood as meaning various types of cooking ware for use in ovens or on hot-plates such as frying pans, saucepans, baking trays, pots, etc.

A pan body 12 is formed by means of deep-drawing from the blank, so as to leave an edge 11 (advantageously with a flat surface of at least a few centimetres) projecting radially (for example 3-4 cm) over at least part of the pan circumference. The embodiment shown in FIGS. 1-4 has a projecting edge which is cut so as to extend over the entire circumference of the pan.

As can be seen in FIG. 3, the engaging seat 15 for the handle 14 is formed in the projecting edge, as indicated by broken lines in FIG. 4.

Advantageously, this engaging seat comprises a cut zone on the projecting edge so as to form an engaging through-hole 16. Advantageously, as shown in FIG. 4, the zone which comprises the hole is drawn further so as to have a surface which is staggered (preferably raised) with respect to that of the rest of the projecting edge.

FIGS. 5, 6 and 7 show possible constructional variants of pans according to the method. In particular, in FIG. 5 the projecting edge is lower than a rib 30 drawn so as to project upwards and form the pan containing edge. It should be noted that the projecting edge is off-centre so as to project more on the side where the engaging seat for the handle is formed.

FIG. 6 shows a pan similar to that of FIG. 5, but with the projecting edge which is cut so as to extend over a limited part of the pan circumference.

FIG. 7 shows a saucepan or baking tray with an edge 11 which has two seats for two handles which are spaced along the edge.

As can be clearly seen in FIG. 8, the through-hole is advantageously shaped so as to receive an engaging tooth 17 and a cam-type locking element 19 of the releasable engaging means which are present at the front end of the handle.

The cam element is rotatable about a pin 27 by means of a lever 18 so as to pass from a free condition for insertion of the tooth 17 into the hole and underneath the rim of the hole (as can be clearly seen in FIG. 9) and a position rotated through 90° (FIG. 8) where the cam grips the opposite edge of the hole against a projecting part 20 of the handle engaging mechanism. A tooth 26 underneath the cam prevents extraction. In the case of an aluminium pan a strip element 40 may also be arranged between cam and edge of the hole so that there is pressure only against the edge of the hole and no sliding friction during rotation of the cam. This prevents wear of the aluminium edge.

At this point it is clear how the predefined objects have been achieved, forming in a simple and low-cost manner a pan having, incorporated, an engaging seat for a removable handle.

Obviously, the above description of an embodiment applying the innovative principles of the present invention is provided by way of example of these innovative principles and must therefore not be regarded as limiting the scope of the rights claimed herein. For example, the shape and size of the various parts may obviously vary depending on the specific requirements. The handle itself may have any shape. Although manufacture in aluminium is particularly advantageous, other metallic materials suitable for use, such as iron or steel, may be used. The pan may also have a surface lined with a suitable non-adhesive layer. The production steps may also be combined or their order changed. For example, cutting of the hole may be performed together with that of the blank and/or the forming steps may be divided up into several substeps or, instead, combined as one step. The hole itself may also be made so that it is not continuous, for example by cutting only a front zone for the tooth and a rear zone for the contact surface of the cam which are separated by a simple drawn zone or discontinuity on the surface which allows the engaging movement.

During the pan drawing and pressing operations ornamental designs or other elements which might be required may also be formed on the surface of the edge or the pan. A step for folding or flanging the end of the edge of the pan could also be envisaged in order to provide greater rigidity.

1. Method for the production of a pan having, incorporated, at least one engaging seat for a handle with releasable engaging means at its end, comprising the steps of cutting a blank from a metal sheet, forming by means of deep-drawing from said blank a pan body, leaving an edge which projects radially over at least a part of the pan circumference, and forming in this projecting edge the said engaging seat for the handle.

2. Method according to claim 1, wherein the seat forming step comprises cutting the projecting edge in order to form a shaped through-hole for receiving an engaging tooth and a cam-type locking element of the said releasable engaging means present on the handle.

3. Method according to claim 2, wherein the zone which comprises the said hole is drawn further so as to obtain a surface which is staggered with respect to that of the rest of the projecting edge.

4. Method according to claim 1, wherein the step of cutting a blank from a metal sheet comprises cutting a blank from a metal sheet made of aluminum.

5. Method according to claim 1, wherein the step of forming a projecting edge comprises forming said projecting edge such that said projecting edge is cut so as to extend over the entire circumference of the pan.

6. Method according to claim 1, the step of forming a projecting edge comprises cutting said projecting edge is cut so as to extend over a limited part of the pan circumference.

7. (canceled)

8. A pan having at least one engaging seat for a handle with releasable engaging means at its end, wherein said pan is made by the method comprising the steps of cutting a blank from a metal sheet, forming by means of deep-drawing from said blank a pan body, leaving an edge which projects radially over at least a part of the pan circumference, and forming in this projecting edge the said engaging seat for the handle.
